(19) United States
(12) Patent Application Publication
(10) Pub. No.: US 2025/0303469 A1
(43) Pub. Date: Oct. 2, 2025

(54) Calibration System for an Energy Beam of an Additive Manufacturing Device

(71) Applicant: EOS GMBH ELECTRO OPTICAL SYSTEMS, Krailling (DE)

(72) Inventors: Stefan Paternoster, Andechs (DE); Hans Perret, München (DE)

(21) Appl. No.: 18/862,166

(22) PCT Filed: May 3, 2023
(86) PCT No.: PCT/EP2023/061730

§ 371 Date: Oct. 31, 2024

(30) Foreign Application Priority Data
May 12, 2022 (DE) 10 2022 111 992.0

(51) Int. Cl. B22F 10/31; B22F 10/32; B22F 12/41; B22F 12/90; B33Y 30/00; B33Y 40/00

(52) U.S. Cl. CPC B22F 10/31; B22F 10/32; B22F 12/41; B22F 12/90; B33Y 30/00; B33Y 40/00

(57) ABSTRACT

Disclosed is a calibration system for an energy beam of an additive manufacturing device. The calibration system includes an additive manufacturing device with a beam inlet, a gas supply, and a measuring unit for detecting a beam property of the energy beam. In addition, the calibration system includes a calibration aid with a hollow space and an inflow opening for introducing the gas into the hollow space. The calibration aid is arranged in the additive manufacturing device and the energy beam is surrounded by the hollow space from the beam inlet to the measuring unit. For calibration purposes, the gas flows into the hollow space. Further disclosed is a method for calibrating an energy beam and to the use of a calibration aid for calibrating an energy beam.

The present invention relates to a calibration system and a method and use of a calibration aid for calibrating an energy beam.

Additive manufacturing processes are becoming increasingly relevant in the production of prototypes and now also in series manufacture. In general, “additive manufacturing processes” are manufacturing processes in which a manufacturing product or component is built up by depositing material, usually on the basis of digital 3D design data. The structure is usually created by applying a build-up material in layers and selectively solidifying it. The term “3D printing” is often used as a synonym for additive manufacturing; the production of models, samples and prototypes using additive manufacturing processes is often referred to as “rapid prototyping”, the production of tools as “rapid tooling”, and the production of series products as “direct manufacturing”.

The selective solidification of the build-up material is often achieved by repeatedly applying thin layers of the usually powdery build-up material on top of each other and solidifying them by spatially limited irradiation using an energy beam, e.g. by means of light and/or heat and/or particle radiation, at the points that, after manufacture, are to form part of the manufactured product to be produced. An example of a method that works with irradiation is “laser powder bed fusion” or “selective laser melting”. The powder grains of the build-up material are partially or completely melted during the solidification process with the help of the energy introduced locally at this point by the radiation. After cooling, these powder grains are then bonded together in the form of a solid.

In this type of production, it is often necessary for a process gas to be passed through the process chamber for inertisation, cooling or removal purposes (in particular with a fan). This means that the additive manufacturing process takes place under a process gas atmosphere that differs in its properties—possibly significantly—from the normal ambient atmosphere. For example, the process gas atmosphere may have a lower humidity content than the normal ambient atmosphere.

Sometimes it is necessary to calibrate the energy beam in order to optimise the properties of the energy beam for manufacture. To do this, a measuring instrument is inserted into the beam path that records the measured values for certain beam properties of the energy beam. In order to provide the same atmosphere as in additive manufacturing for calibration, the entire process chamber is usually flooded with the process gas for calibration. This is particularly time-consuming if several calibration steps have to be carried out and/or the process chamber first has to be brought back to a normal ambient atmosphere in order to open it safely.

The problem addressed by the present invention is that of simplifying the calibration of an energy beam of an additive manufacturing device.

This problem is solved by a calibration system according to claim 1, a method for calibrating an energy beam according to claim 13, and the use of a calibration aid for calibrating an energy beam according to claim 15.

The aforementioned calibration system for an energy beam of an additive manufacturing device comprises an additive manufacturing device with a beam inlet for the energy beam. It also comprises a gas supply for providing a gas that is suitable for calibration, a measuring unit for detecting a beam property of the energy beam and a calibration aid with a hollow space and an inflow opening for introducing the gas into the hollow space. The calibration aid is arranged in the additive manufacturing device in such a way that the energy beam is surrounded by the hollow space from the beam inlet to the measuring unit, and the gas flows into the hollow space for calibration.

The energy beam is basically any energy beam that is suitable for selective melting or sintering of a corresponding material for additive manufacturing. For example, the energy beam is generated by means of a laser, preferably a CO laser. It can also be a CO2 laser, a diode laser, in particular a diode laser with a wavelength of 4-7 μm, a Nd:YAG laser, an electron beam or the like.

During operation, the energy beam enters the process chamber or the construction space of the additive manufacturing device via the—at least one—beam inlet. The beam inlet can be designed in a simple manner as an opening or aperture in the process chamber.

However, in order to keep the volume of the areas to be filled with process gas small, the process chamber is preferably separated gas-tightly from other areas of the additive manufacturing device, such as an optical chamber for the optical elements for adjusting the energy beam. The beam inlet is therefore designed, for example, as a coupling window that is transparent to the energy beam.

The gas that is suitable for calibration is selected depending on the energy beam, i.e. depending on the type of energy beam. It has at least similar optical properties to the process gas. In the case of a CO laser, dry air or nitrogen is preferably suitable as the energy beam for calibration. The gas is provided, for example, by means of a gas cylinder, a separate in-house gas supply, or preferably by means of the gas supply of the additive manufacturing device.

The hollow space of the calibration aid is surrounded by a hollow body. The hollow body can be formed substantially by corresponding elements of the calibration aid. Alternatively, the hollow body is formed by the interaction of elements of the calibration aid with elements of the additive manufacturing device, such as a wall of the process chamber and/or the coupling window or beam inlet. In this way, the energy beam is simultaneously housed from the beam inlet to the measuring unit or measuring instrument during intended operation. This means that the beam route or beam path of the energy beam is largely surrounded within the process chamber by the beam inlet, the calibration aid and the measuring instrument. It runs through the hollow space of the calibration aid. This means that the beam path in the calibration system is shielded from the ambient atmosphere, which may have properties that would hinder precise calibration. This improves the reproducibility of the calibration.

For calibration, the gas flows or is introduced into the hollow space of the calibration aid through the inflow opening. For this purpose, the inflow opening is fluidically connected to the gas supply, e.g. by means of a hose or the like.

The measuring unit is designed depending on the beam property of the energy beam to be detected. If, for example, the power of the energy beam is measured or detected as a beam property by means of the measuring unit, the measuring unit is designed as a power meter. It is arranged adjacent to the calibration aid and preferably attached to it in such a way that the energy beam impinges on a measuring region of the measuring unit.

The calibration aid is therefore preferably an additional unit that can be easily separated from the additive manufacturing device or removed from the process chamber and is only inserted into the process chamber for the calibration of the energy beam.

Accordingly, the aforementioned method for calibrating an energy beam of an additive manufacturing device comprising a beam inlet has at least the following steps: In one step, a calibration aid is provided, which comprises a hollow space and an inflow opening for introducing a gas that is suitable for the calibration. In a further step, the calibration aid is introduced into the additive manufacturing device so that the energy beam is largely surrounded by the hollow space from the beam inlet to a measuring unit. In a further step, gas flows into the hollow space of the calibration aid. Meanwhile, the calibration of the beam path is carried out in a subsequent step. The measuring unit detects a beam property of the energy beam.

The method therefore substantially comprises the functional features of the calibration system described above. Once calibration has been completed, the calibration aid and the measuring unit are preferably removed from the process chamber in order to be able to carry out additive manufacturing processes using the additive manufacturing device.

As aforementioned, a calibration aid is used in accordance with the invention to calibrate an energy beam of an additive manufacturing device. The calibration aid is inserted with its hollow space into the additive manufacturing device so that the energy beam is surrounded in the hollow space from the beam inlet to a measuring unit. During the calibration of the beam path, a gas that is suitable for the calibration flows into the hollow space of the calibration aid and a beam property of the energy beam is detected by means of the measuring unit.

Compared to flooding the entire process chamber, the use of the calibration aid according to the invention in the process chamber of an additive manufacturing device therefore advantageously reduces the volume into which the gas that is suitable for calibration in order to calibrate the energy beam flows or floods. This reduces the time required for calibration in particular. This is particularly the case if several calibration steps and therefore several floodings are necessary after a new, adapted setting of the energy beam.

Further, particularly advantageous embodiments and developments of the invention can be found in the dependent claims and the following description, wherein the independent claims of one claim category can also be developed analogously to the dependent claims and exemplary embodiments of another claim category and, in particular, individual features of different exemplary embodiments or variants can also be combined to form new exemplary embodiments or variants.

The gas that is suitable for calibration is referred to below as “gas”. Preferably, the gas is fed into the hollow space in such a way that a relative humidity of below 5% is maintained in the hollow space during calibration, particularly preferably below 4%, very particularly preferably below 3%. As described above, the relative humidity is relevant for the beam properties of a CO laser or a diode laser with a wavelength of 4-7 μm, for example. Since the relative humidity in an additive manufacturing process is similarly low to the preferred humidity values, it is advantageous to calibrate the energy beam under these conditions as well. Preferably, a temperature of the gas during calibration is at least 10° C. and/or at most 50° C.

By contrast, a typical relative ambient humidity prevails in the remaining volume of the process chamber of the additive manufacturing device during the flow into the hollow space and is preferably greater than 3% on average, further preferably greater than 5%, still further preferably greater than 10%, particularly preferably greater than 20%.

The hollow space of the calibration system, i.e. the volume between the beam inlet, the calibration aid and the measuring instrument, does not have to be gas-tight. Preferably, it has small gaps, e.g. at the connection points between the individual elements, through which the gas can flow out. This advantageously displaces the gas composition of the ambient atmosphere from the hollow space, particularly when the hollow space is first flooded with the gas.

The gas is preferably provided by the gas supply of the additive manufacturing device. This is advantageous as the same gas is used directly as in the manufacturing process and therefore substantially the same optical conditions prevail as in the process gas atmosphere.

The gas is preferably introduced into the hollow space via a separate connection or inlet in the process chamber. This means that an additional gas connection or gas inlet for the calibration is preferably arranged in the process chamber. For calibration, it is therefore preferable not to use one or more existing gas inlets in the process chamber, which are used for relatively large-volume inertisation and/or cleaning of the process chamber volume of impurities in the process gas. The inlets for the manufacturing process therefore do not need to be adjusted. In addition, the separate connection for calibration can preferably be actuated or controlled independently of the other inlets. For example, the previously mentioned relative humidity values in the hollow space can also be achieved thanks to the adjustable volume flow of the gas for calibration.

According to an alternative preferred embodiment, a number of existing gas inlets in the process chamber are used to provide the gas that is suitable for calibration. For this purpose, the gas is preferably supplied to the additive manufacturing device by means of an inflow device assigned to a number of jet inlets. In regular manufacturing operation, the inflow device or purging device is used for the directed inflow of at least one beam inlet or laser window or coupling window. To perform the calibration, the inflow device is activated and controlled or actuated separately, while other devices for global flooding/flowing of the process chamber with process gas/inert gas can be deactivated at the same time. The inflow device therefore supplies the inflow opening of the calibration aid with the gas that is suitable for the calibration to perform the calibration.

For example, the hollow space of the calibration aid can be docked to an opening (gas inlet) of the inflow device on the process chamber side in the intended position and direct the gas into the area between the beam inlet or coupling window and the measuring unit during calibration. Relative gas tightness can be achieved, for example, by designing the calibration aid to complement the geometry of the ceiling wall in certain areas. This means that, due to its shape, the calibration aid adjoins the wall or ceiling wall of the process chamber substantially gas-tightly—e.g. through appropriate positioning and manufacturing accuracy and/or by means of additional seals.

The calibration aid preferably forms the hollow space in an intended position in co-operation with a process chamber wall of the additive manufacturing device. The inflow opening of the calibration aid is particularly preferably located at a gas outlet opening of the inflow device and is fluidically connected to it.

The hollow space thus serves as a gas duct or as a gas channel and can be implemented, for example, by recesses or a design of the calibration aid which, in the intended position, comprises surfaces that are spaced apart from the process chamber wall in certain areas. In the intended docked state on the inflow device and/or on a process chamber ceiling and/or wall, the calibration aid according to the invention can form the hollow space, i.e. a gap or channel through which the flow passes, with the measuring unit. The hollow space formed in this way can have an outflow opening which, during intended operation, is the only opening of the calibration aid that allows the inflowing gas to escape into the interior of the process chamber.

An advantageous synergy effect results from the fact that such inflow devices are generally arranged on a ceiling wall of the process chamber and in the vicinity of the existing number of beam inlets or coupling windows. Their use in the method or calibration system according to the invention therefore serves a further purpose outside the manufacturing process, so that any additional connections, valves and/or conduits that may otherwise be required are advantageously saved.

The hollow space preferably has a variable height. In other words, the distance between the beam inlet and the measuring unit can be set or adjusted by means of the hollow space, in particular by means of the elements that form the hollow body. This allows, for example, the beam properties of the energy beam to be calibrated in different height positions of the manufacturing plane or the construction field. Detailed embodiments are described below.

In order to vary the height, the hollow space is preferably designed to be expandable. For this purpose, the hollow space, i.e. in particular the hollow body, can preferably be made of an elastic material, in particular as a hose. Alternatively or additionally, it can particularly preferably be designed as a bellows or similarly stretchable element. At the very least, the hollow body preferably has correspondingly stretchable areas. This design allows the height position of the measuring unit to be varied, as well as the position within the manufacturing plane perpendicular to the height.

Furthermore, the hollow space or the hollow body can be designed particularly preferably as an elastic tent or as a tent in the form of a bellows. It can have a pyramid or cone shape, for example. In contrast to a substantially linear or tubular design of the hollow body, a tent-like, pyramid-shaped or cone-shaped design makes it possible to carry out calibration measurements over the entire construction field without repositioning the calibration aid.

In order to vary the height, the hollow space or hollow body is alternatively or additionally preferably designed to be extendable. In other words, it has at least one extendable part or an extension. It can also comprise rigid components. The extension can be a telescopic extension, for example.

Preferably, the calibration aid has a joint at at least one, particularly preferably at each, end of the hollow body. The joint can be a simple swivel joint or a combination of several joints, for example. The joint can also be bellows-like, for example. However, the joint is particularly preferably designed as a ball joint. By means of the joint, especially in combination with the variable height of the hollow space or hollow body, the measuring unit can be positioned advantageously at different positions in the manufacturing plane, especially at different positions required for calibration, with any height settings of the manufacturing plane. The beam path remains surrounded by the hollow body or surrounded in its hollow space so that the energy beam, during calibration, passes through the gas that is suitable for calibration.

The calibration aid is preferably designed to be self-retaining. This means that it is preferably designed in such a way that it retains a height and/or joint position once it has been set. The calibration aid is therefore particularly preferably designed to be self-retaining in such a way that it remains fixed in position and/or dimensionally stable in the additive manufacturing device.

This is achieved, for example, by creating frictional resistance between the individual adjustable elements. The frictional resistance can be generated by a relatively small clearance and/or corresponding surface properties, in particular by a suitable surface roughness of the elements. The frictional resistance is preferably easy to overcome during manual adjustment, but is sufficient for the individual elements to maintain their relative position or arrangement without external influence.

The calibration system preferably has fastening means for attaching the calibration aid to the additive manufacturing device. The fastening means are arranged, for example, on the calibration aid or the additive manufacturing device. They are preferably designed as complementary elements that form a form fit and/or frictional engagement. The calibration aid can be implemented, for example, with the aid of clamping screws or a clip fastener, in particular by means of manually releasable, form-fit latching lugs, other form-fit elements and/or the like. The calibration aid is preferably fastened in the area of the beam entry into the process chamber or coupling window for the energy beam.

In the additive manufacturing device, the calibration aid preferably extends over a partial or complete distance between a manufacturing plane or the construction field and a beam inlet of the additive manufacturing device. This means that the calibration aid is attached to the coupling window, for example, as described above, but does not extend completely from there to the manufacturing plane, but holds the measuring unit—virtually floating—in a position between the manufacturing plane and the beam inlet.

The hollow body of the calibration aid preferably completely surrounds the energy beam from the position where the energy beam passes through the beam inlet or the coupling window until it hits the measuring unit. The volume surrounded by the hollow body, i.e. the hollow space, is preferably smaller than the volume of the process chamber, in particular smaller than a third, more preferably smaller than a quarter, even more preferably smaller than a tenth, particularly preferably smaller than a fiftieth, very particularly preferably smaller than a hundredth of the volume of the process chamber. The ratio and the resulting savings effect continue to improve with increasing size of the construction space. Accordingly, the time required for flooding the volume for calibration according to the invention is also advantageously shorter.

The calibration aid and/or the measuring unit are preferably removable from the process chamber and are removed from the process chamber before an additive manufacturing process. This means that before start of operation of the additive manufacturing device or after a preceding additive manufacturing process, a calibration according to the invention is preferably carried out, the calibration aid and/or the measuring unit is then preferably removed from the process chamber, and a new, subsequent additive manufacturing process is then carried out.

This means that an additive manufacturing process preferably does not take place during calibration. As a result, the flow to the process chamber, which can be provided, for example, by a circulation system for supplying and returning process gas, possibly with filtering of contaminated process gas, is particularly preferably deactivated during calibration with the calibration system according to the invention. This advantageously saves process gas or the energy required to circulate the process gas.

The property of the energy beam, which is recorded for calibration, preferably comprises a beam power, an intensity distribution, a focus position, a focus geometry and/or a response behaviour of the energy beam. Alternatively or additionally, properties of an energy beam deflection device (e.g. a galvanometer scanner) can also be measured, e.g. the positional accuracy of one or more deflection devices relative to each other.

A typical power meter is used to determine the laser power, for example, as described above. The laser power is preferably not measured in the focal point or focus, but outside the focus, as the intensity in the focus may be too high at certain points. If the focal point is in the manufacturing plane, for example, the power meter is simply placed on the manufacturing plane or a construction platform. The offset to the focal point created in this way is sufficient for the power measurement, as the power meter can still measure the entire power in this way without the intensity being too high at one point.

The focus position indicates the position of the focus in three-dimensional space in relation to the additive manufacturing device, i.e. in particular a height above the manufacturing plane or a distance to the beam inlet as well as a two-dimensional position in a plane parallel to the manufacturing plane. The focus geometry indicates whether the focus is circular, elliptical, in particular with an indication of the main axes, or otherwise shaped. The focus position and the focus geometry can be determined, for example, using a focus monitor as a measuring unit. This can be realised in a simple way, for example, by means of a power meter with a pinhole (dot-shaped aperture) in front of it.

The response behaviour of the energy beam describes a reaction delay or power curve when switching on, switching off or when the power requirement changes. Thermal paper, for example, can be used as a measuring unit for the response behaviour. The corresponding properties of the response behaviour can be determined after the calibration measurements.

The invention is explained in greater detail below with reference to the attached figures on the basis of exemplary embodiments. In the various figures, identical components are provided with identical reference signs. The figures are generally not to scale and show

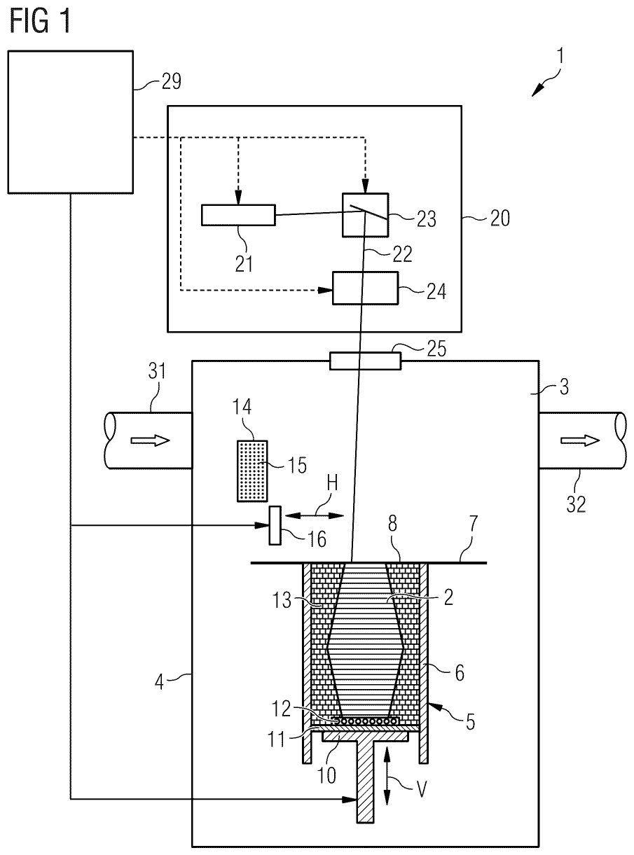

FIG. 1 a schematic, partially sectional view of an additive manufacturing device for the additive manufacturing of a three-dimensional object,

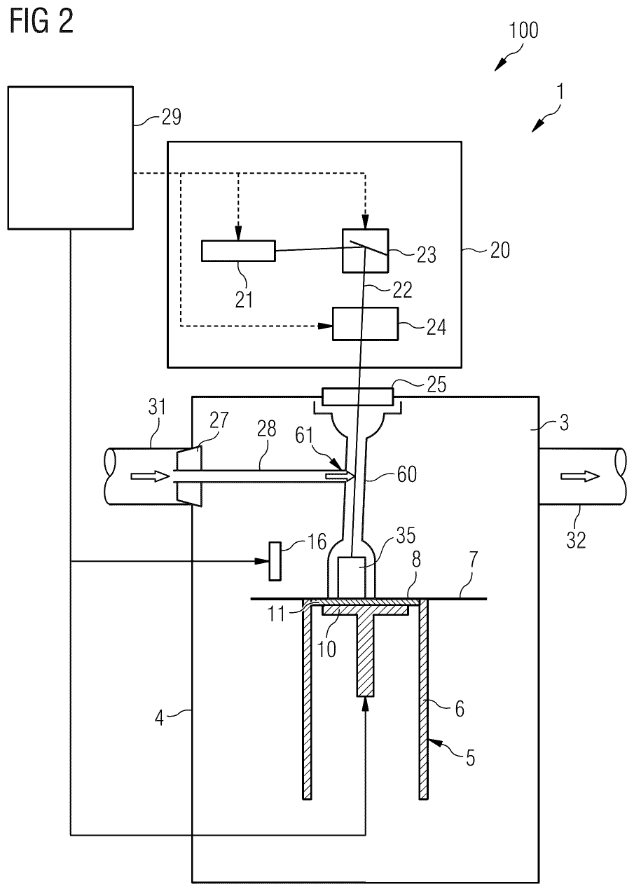

FIG. 2 a schematic view, partially shown in section, of an exemplary embodiment of a calibration system according to the invention for an energy beam of an additive manufacturing device,

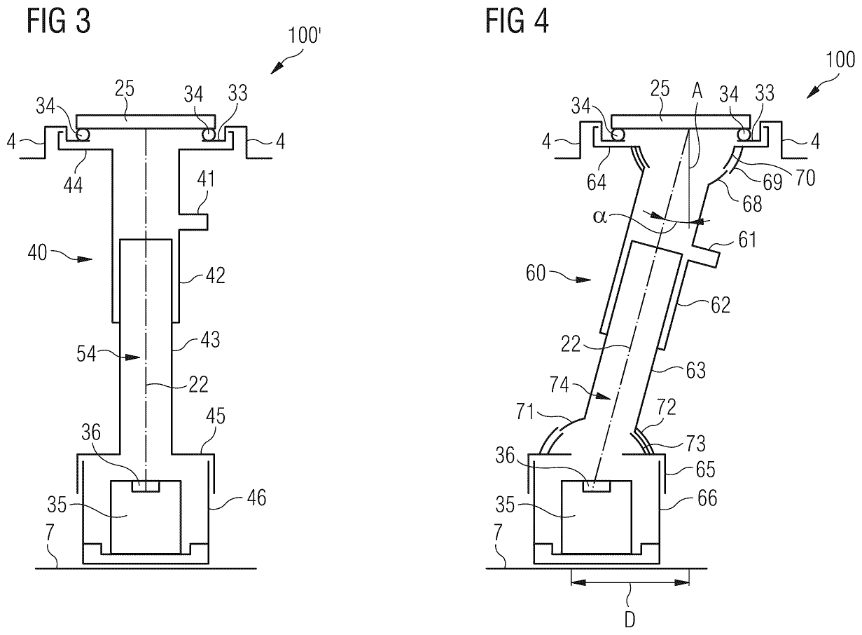

FIG. 3 a schematic detailed view, shown in section, of a further exemplary embodiment of a calibration system according to the invention,

FIG. 4 a schematic, sectional view of the calibration system shown in FIG. 2,

FIG. 5 a schematic perspective detailed view of a further exemplary embodiment of a calibration system according to the invention,

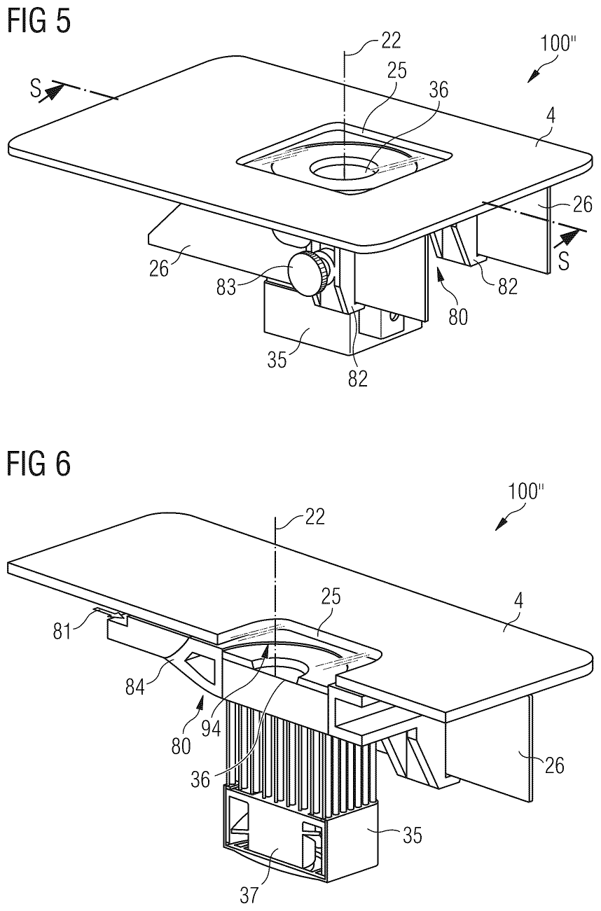

FIG. 6 a sectional view of the calibration system from FIG. 5,

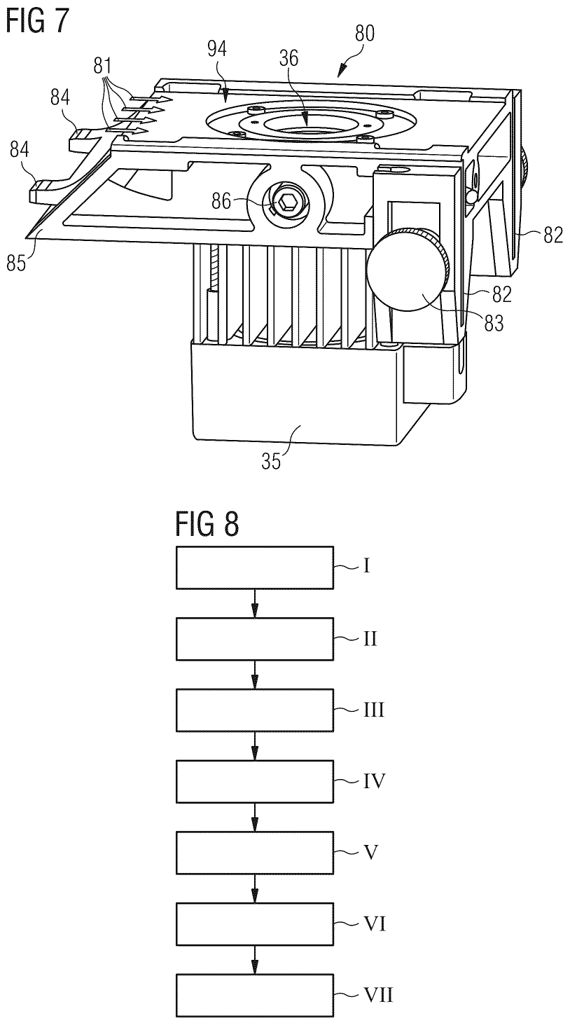

FIG. 7 a detailed perspective view of the calibration aid shown in FIG. 5 with a measuring unit, and

FIG. 8 a block diagram of an exemplary embodiment of a method according to the invention for calibrating an energy beam of an additive manufacturing device.

With reference to FIG. 1, an additive manufacturing device 1 for a three-dimensional object is described below. The manufacturing device 1 shown schematically and partially in section in FIG. 1 is a selectively acting laser melting device 1. To build up an object 2, it contains a process chamber 3 with a chamber wall 4.

An upwardly open container 5 with a container wall 6 is arranged in the process chamber 3. A manufacturing plane 7 is defined by the upper opening of the container 5, wherein the area of the manufacturing plane 7 within the opening that can be used to build the object 2 is referred to as the construction area 8. In addition, the process chamber 3 comprises a process gas supply 31 associated with the process chamber 3 and a process gas outlet 32.

In the container 5 there is arranged a carrier 10 movable in a vertical direction V, to which a base plate 11 is attached, which closes the container 5 at the bottom and thus forms its base. The base plate 11 can be a plate formed separately from the carrier 10, which is attached to the carrier 10, or it can be formed integrally with the carrier 10. Depending on the powder and process used, a construction platform 12 can also be attached to the base plate 11 as a construction base on which the object 2 is built. However, the object 2 can also be built on the base plate 11 itself, which then serves as a construction base. In FIG. 1, the object 2 to be formed in the container 5 on the construction platform 12 is shown below the working plane 7 in an intermediate state with several solidified layers surrounded by unsolidified build-up material 13.

The laser melting device 1 also contains a storage container 14 for a powdery build-up material 15 that can be solidified by electromagnetic radiation and a coater 16 that can be moved in a horizontal direction H for applying the stored build-up material 15 within the construction field 8. Preferably, the coater 16 extends transversely to its direction of movement over the entire area to be coated.

The laser melting device 1 further comprises an exposure device 20 with a laser 21, preferably a CO laser, which generates a laser beam 22 that is deflected via a deflection device 23 and focused onto the working plane 7 by a focusing device 24 via a beam inlet 25 or a coupling window 25, which is attached to the top of the process chamber 3 in the chamber wall 4.

Furthermore, the laser melting device 1 contains a control unit 29, via which the individual components of the laser melting device 1 are controlled in a coordinated manner to carry out the construction process. Alternatively, the control unit 29 can also be mounted partially or completely outside the laser melting device 1. The control unit may include a CPU, the operation of which is controlled by a computer program (software). The computer program can be stored separately from the laser melting device 1 on a storage medium from which it can be loaded into the laser melting device 1, in particular into the control unit 29.

A powdery material is preferably used as the build-up material 15, wherein it can be, for example, a metal-containing or metal-based build-up material, but preferably a polymer-containing, particularly preferably a polymer-based (>50 wt. % polymer content) build-up material.

To apply a layer of powder during operation, the carrier 10 is first lowered by a height that corresponds to the desired layer thickness. The coater 16 first travels to the storage container 14 and takes a sufficient quantity of the build-up material 15 from it to apply a layer. It then travels over the construction area 8, where it applies powdered build-up material 15 to the construction base 12 or a previously existing powder layer and draws it out to form a powder layer. The application takes place at least over the entire cross-section of the object 2 to be produced, preferably over the entire construction area 8, i.e. the area bounded by the container wall 6. Optionally, the powdered build-up material 15 is heated to a working temperature by means of radiant heating.

The cross-section of the object 2 to be produced is then scanned by the laser beam 22 so that the powdery build-up material 15 is solidified at the points that correspond to the cross-section of the object 2 to be produced. The powder grains are partially or completely melted at these points by means of the energy introduced by the radiation, so that they are bonded together as solid bodies after cooling. These steps are repeated until the object 2 is finished and can be removed from the process chamber 3.

FIG. 2 shows a schematic view, partially shown in section, of an exemplary embodiment of a calibration system 100 according to the invention for an energy beam 22, in particular the beam of a CO laser, of an additive manufacturing device 1. The additive manufacturing device 1 corresponds to the additive manufacturing device 1 from FIG. 1. However, for better visualisation of the calibration system 100, some elements of the additive manufacturing device 1 are not shown here. The carrier 10 and the base plate 11 are arranged here in a starting position adjacent to the manufacturing plane 7 or the construction area 8.

In addition to the additive manufacturing device 1, the calibration system 100 comprises a calibration aid 60 and a measuring unit 35. The measuring unit 35 is designed here as a power meter 35 for measuring the laser power as a beam property and is positioned in the beam path of the laser beam 22 on the manufacturing plane 7.

The beam path of the laser 22 within the process chamber 3 is surrounded by the calibration aid 60 from the coupling window 25 to the power meter 35. The calibration aid 60 has an inflow opening 61, which is fluidically connected to the process gas supply 31 by means of a hose 26 and a stopper 27 in an exemplary simple design. During calibration, the interior or hollow space 74 (see FIG. 4) of the calibration aid 60 is supplied with process gas, in particular nitrogen, as illustrated by the arrows. The process gas penetrates through small gaps between the elements of the calibration aid 60 and displaces the gas composition of the surrounding atmosphere from the calibration aid 60. As the process gas is identical for the manufacturing process and for the calibration process, it is a suitable gas for calibration as it has the same optical properties. For example, the injected gas achieves a relative humidity of less than 3% in the hollow space of the calibration aid, wherein the humidity has an influence on the calibration or the beam properties, particularly in the case of CO lasers.

The calibration aid 60 is described in detail in FIG. 4.

FIG. 3 shows schematically and in section a detailed view of a further exemplary embodiment of a calibration system 100′ according to the invention. For better visualisation, only the manufacturing plane 7 and the upper side of the chamber wall 4 with the coupling window 25, which separates the irradiation device 20 or the optical chamber from the process chamber 3 gas-tightly by means of a circumferential seal 34, are shown here (see also FIG. 1).

The calibration aid 40 comprises an upper part 42 and a lower part 43. The upper part 42 and the lower part 43 are substantially cylindrical in shape and arranged concentrically, so that together they form a hollow body with a hollow space 54. An outer dimension of the lower part 43 is dimensioned in relation to an inner dimension of the upper part 42 in such a way that they can be telescopically displaced relative to one another. This allows the height of the calibration aid, i.e. the distance from the free end of the upper part 42 to the free end of the lower part 43, to be varied or adjusted. Preferably, the upper part 42 and the lower part 43 are dimensioned in such a way that they form a frictional connection without the application of manual force, which automatically holds the lower part 42 and other components attached to it.

An upper receptacle 44 is formed at the free end of the upper part 42. The upper side of the chamber wall 4 has a ledge 33 in the area around the coupling window 25. The ledge 33 is substantially surrounded by the upper receptacle 44 of the calibration aid 40 with a precise fit, i.e. with only a small gap. The ledge 33 and the upper receptacle 44 thus have complementary shapes. For example, they can be arranged concentrically, circularly or squarely around the coupling window 25. The upper receptacle 44 is preferably manufactured to fit precisely so that a frictional connection is created with the ledge 33. This creates a simple plug-in connection. Alternatively, the upper receptacle 44 can also be connected to the ledge 33 with fastening means such as clamping screws and/or a clip fastener in a frictionally engaged and/or form-fitting manner.

The upper part 42 also has an inflow opening 41, which can be fluidically connected to the gas supply, in particular the process gas supply 31, for example with the aid of a hose 26 (see FIG. 2). The inflow opening 41 is preferably arranged closer to or adjacent to the free end of the upper part 42.

A lower receptacle 45 is formed at the free end of the lower part 42. The lower receptacle 45 is manufactured to fit a holder 46 for the measuring unit 35 precisely and surrounds its opening facing the coupling window 25. Here too, “precise fit” preferably means that a frictional connection is created between the lower receptacle 45 and the holder 46, so that a simple plug-in connection is formed. Alternatively, the fastening means specified above can also be used here, for example.

The calibration aid 40 is thus preferably designed in such a way that it automatically maintains a height once it has been set and thus also holds the measuring unit 35 in its holder 46 when suspended from the ledge 33. Only small gaps occur between the elements of the calibration aid 40 and the connection points with the ledge 33 and the holder 46, through which only a small amount of the gas that is suitable for calibration and introduced through the inflow opening 41 can escape. The hollow space 54 is therefore filled with the gas that is suitable for calibration after initial flooding and is lightly flowed through by it, so that gases from the surrounding atmosphere do not penetrate into the calibration aid 40. The entire beam path of the laser beam 22 running through the process chamber 3 is therefore surrounded by the calibration aid 40 and runs from the coupling window 25 through the gas that is suitable for calibration until it encounters a measuring window 36 or measuring region 36 of the measuring unit 35. As a result, the laser beam 22 can substantially be calibrated under the same conditions, i.e. with the same optical properties, under which a subsequent additive manufacturing process is also carried out.

After calibration, the plug connections of the calibration aid 40 (and, if applicable, its fastening means) with the ledge 33 and with the holder 46 can be released and the calibration aid 40 can be removed from the process chamber 3. To facilitate removal, the calibration aid 40 can be pushed together between its upper part 42 and its lower part 43, e.g. using the telescopic height adjustment.

FIG. 4 shows a schematic sectional view of the calibration system from FIG. 2 in detail. The calibration aid 60 shown here is similar to the calibration aid 40 from FIG. 3, but in contrast, the calibration aid 60 has two ball joints 68, 69, 70, 71, 72, 73.

An upper ball joint 68, 69, 70 is formed between the upper receptacle 64 and the upper part 62. It comprises a centre spherical cap 68, an outer spherical cap 69 and an inner spherical cap 70, which are arranged concentrically. The spherical caps 68, 69, 70 are shaped as a spherical cap or as a layer of a spherical cap and have radii that increase in relation to each other from the inside to the outside. The outer spherical cap 69 and the inner spherical cap 70 are formed on the upper receptacle 64. The centre spherical cap 68 is formed on the upper part 62. Compared to the outer spherical cap 69 and the inner spherical cap 70, it is shaped as a spherical layer lying closer to the pole of the ball and thus partially engages between the outer spherical cap 69 and the inner spherical cap 70. The upper part 62 is thus mounted movably or rotatably in relation to the upper receptacle 64 about the common centre of the spherical caps 68, 69, 70. The manufacture of such a pivot bearing 68, 69, 70 composed of interlocking spherical caps 68, 69, 70 is possible, for example, by means of additive manufacturing.

A lower ball joint 71, 72, 73 is formed between the lower receptacle 65 and the lower part 63 in the same way as the upper ball joint 68, 69, 70. Here too, a centre spherical cap 71 arranged on the lower part 63 engages between an inner spherical cap 73 and an outer spherical cap 72, both of which are formed on the lower receptacle 65. Like the telescopic connection between the upper part 62 and the lower part 63, the two ball joints 68, 69, 70, 71, 72, 73 are preferably designed to be self-retaining due to the frictional resistance between them.

By means of the ball joints 68, 69, 70, 71, 72, 73, the measuring unit 35 can be positioned at an offset D to a position on a central vertical axis A of the coupling window 25. This makes it possible to also calibrate the beam properties of laser beams 22 that run at an angle α oblique to the central vertical axis A.

FIGS. 5 and 6 show a schematic perspective view of a further exemplary embodiment of a calibration system 100″ according to the invention. FIG. 6 shows a sectional view along the plane of section S labelled in FIG. 5. For better visualisation, only the upper side of the chamber wall 4 is shown here in detail.

A coupling window 25 is arranged in a recess in the upper side of the chamber wall 4. Through the coupling window 25, a laser beam 22 is incident on a measuring region 36 of a measuring unit 35, which is arranged inside the process chamber 3 (see FIG. 1). The measuring unit 35 also has a fan 37 with cooling fins to dissipate any heat generated.

The measuring unit 35 is attached adjacent to the coupling window 25 by means of the calibration aid 80. For exact positioning and fastening, the calibration aid 80 has two pins 84 (see FIGS. 6 and 7), which engage form-fittingly in complementary elements (not shown), which are rigidly connected to the chamber wall 4. By means of the pins 84 and the complementary elements, the calibration aid 80 and thus also the measuring unit 35 is guided precisely into the position required for the measurement. In addition, plates 26 are arranged parallel to the plane of section S on both sides next to the coupling window 25 for fastening. The plates 26 are each gripped by a fastening clamp 82 of the calibration aid 80. By means of the fastening clamps 82 and a knurled screw 83 in each case, the calibration aid 80 is fastened to the plates 26 in a frictionally engaged manner.

A hollow space 94 is arranged between the coupling window 25 and the measuring region 36 of the measuring unit 35, which is surrounded by the hollow body of the calibration aid 80. Compared with the exemplary embodiments in FIGS. 3 and 4, the hollow space 94 is flat here, so that the gas that is suitable for calibration flows through it in a substantially laminar manner. This is illustrated in FIG. 7, which schematically shows a perspective view of the calibration aid 80 from FIGS. 5 and 6 with the measuring unit 35, but without the chamber wall 4.

To introduce the gas into the hollow space 94, the calibration aid 80 has an inflow opening 81. The inflow opening 81 is preferably fluidically connected directly to a gas supply (not shown). The gas supply is preferably not the process gas supply intended for the actual circulation of the process gas. The gas supply used here is preferably designed separately from the process gas supply and is preferably controlled separately.

The laser beam 22 thus runs between the coupling window 25 and the measuring region 36 of the measuring unit 35 in the hollow space 94, which is surrounded by the calibration aid 80 and through which the gas that is suitable for calibration flows during calibration. As a result, the laser beam 22 is sealed off from gases from the ambient atmosphere that could have a negative influence on the calibration.

While the calibration aids 40, 60 in FIG. 3 and FIG. 4 are particularly suitable for carrying out a calibration using beam properties that are recorded in the area of the manufacturing plane 7, the calibration aid 80 shown in FIG. 5 to 7 has an advantageously small volume to be flooded and is used for calibration measurements that can be carried out in the area of the coupling window 25, such as a measurement of the total power of the laser beam 22.

FIG. 8 shows a block diagram of an exemplary embodiment of a method according to the invention for calibrating an energy beam 22 of an additive manufacturing device 1.

In a first step I, a number of additive manufacturing processes are carried out using the additive manufacturing device 1. After a predetermined number of manufacturing cycles, a predetermined operating time or if necessary, calibration of the energy beam 22 is required.

For this purpose, a calibration aid 40, 60, 80 is provided in a second step II, which has a hollow body 54, 74, 94 with an inflow opening 41, 61, 81.

In a third step Ill, the calibration aid 40, 60, 80 is introduced into a process chamber 3 of the additive manufacturing device 1 so that it surrounds the energy beam from a coupling window 25 or a beam inlet 25 to a measuring unit 35 for the subsequent calibration.

The inflow opening 41, 61, 81 is fluidically connected to a gas supply so that a gas that is suitable for calibration flows through the hollow body 54, 74, 94 in a fourth step IV.

Calibration is performed under this gas atmosphere in a fifth step V. For this purpose, a beam property, such as the power of the energy beam 22, is recorded by means of the measuring unit 35, e.g. a power meter. Depending on the values measured in this way, adjustments are made to the optics 22, 23 or during the generation 21 of the energy beam 22 until the desired beam property is achieved.

In a sixth step VI, the calibration aid 40 and the measuring unit 35 are removed from the process chamber 3 after calibration.

In a seventh step VII, the calibrated energy beam 22 can be used to perform a number of manufacturing processes until recalibration is required and steps I to VI are repeated.

Lastly, it should be pointed out once again that the figures described in detail above are merely exemplary embodiments which can be modified by a person skilled in the art in various ways without departing from the scope of the invention. Although only a CO laser as an energy beam and nitrogen as a gas that is suitable for calibration were previously described, other types of laser and correspondingly suitable gases or gas mixtures are also included within the scope of the present invention. The calibration aid may also have other embodiments, such as a bellows shape or the like. Furthermore, the use of the indefinite articles “a” or “one” does not exclude the possibility that the features in question may be present more than once. Similarly, the terms “unit”, “device” or “system” do not exclude the possibility that these consist of several interacting sub-components, which may also be spatially distributed.

### LIST OF REFERENCE SIGNS

1 additive manufacturing device/laser melting device
2 object/component
3 process chamber
4 chamber wall
5 container
6 container wall
7 manufacturing plane
8 construction field
10 carrier
11 base plate
12 construction platform
13 unsolidified build-up material
14 storage container
15 build-up material
16 coater
17 radiant heater
20 irradiation device/exposure device
21 laser
22 laser beam, beam path
23 deflection device/scanner
24 focusing device
25 coupling window/beam inlet
26 plate
28 hose
27 stopper
29 control unit
31 process gas supply
32 process gas outlet
33 ledge
34 seal
35 measuring unit
36 measuring region/measuring window
37 fan
40, 60, 80 calibration aid
41, 61, 81 inflow opening
42, 62 upper part
43, 63 lower part
44, 64 upper receptacle
45 lower receptacle
46 holder
54, 74, 94 cavity/hollow body
68, 71 centre spherical cap
69, 72 outer spherical cap
70, 73 inner spherical cap
68, 69, 70 upper ball joint
71, 72, 73 lower ball joint
82 fastening clamp
83 knurled screw
84 pin
100, 100′, 100″ calibration system
A axis
α angle
D offset
V vertical direction
plane of section S
I, II, . . . , VII method steps

1. A calibration system for an energy beam of an additive manufacturing device, said calibration system comprising
an additive manufacturing device with a beam inlet for the energy beam,
a gas supply for providing a gas that is suitable for calibration,
a measuring unit for detecting a beam property of the energy beam, and
a calibration aid with a hollow space and an inflow opening, for introducing the gas into the hollow space, wherein
the calibration aid is arranged in the additive manufacturing device and is an additional unit that can be removed from a process chamber,
the energy beam is surrounded in the hollow space from the beam inlet to the measuring unit and
the gas for calibration flows into the hollow space.

2. The calibration system according to claim 1, wherein the gas is fed into the hollow space such that a relative humidity below 3% is maintained in the hollow space during calibration.

3. The calibration system according to claim 1, wherein the gas is provided by means of the gas supply of the additive manufacturing device.

4. The calibration system according to claim 1, wherein the hollow space has a variable height.

5. The calibration system according to claim 1, wherein the hollow space is extendable to vary the height.

6. The calibration system according to claim 5, wherein the calibration aid has a joint at an end of the hollow space, which joint is designed as a ball joint.

7. The calibration system according to claim 1, wherein the gas is provided by means of an inflow device of the additive manufacturing device associated with a number of beam inlets.

8. The calibration system according to claim 1, wherein the calibration aid forms the hollow space in an intended position in co-operation with a process chamber wall of the additive manufacturing device, wherein the inflow opening of the calibration aid abuts against a gas outlet opening of the inflow device.

9. The calibration system according to claim 1, wherein the calibration aid is designed to be self-retaining.

10. The calibration system according to claim 1, wherein the calibration aid is designed to be self-retaining in such a way that it remains fixed in position and/or dimensionally fixed in the additive manufacturing device.

11. The calibration system according to claim 1, comprising fastening means for attaching the calibration aid to the additive manufacturing device.

12. The calibration system according to claim 1, wherein the calibration aid extends in the additive manufacturing device over a proportional or complete distance between a manufacturing plane and a beam inlet of the additive manufacturing device.

13. A method for calibrating an energy beam of an additive manufacturing device comprising a beam inlet, said method having at least the following steps:
providing a calibration aid comprising a hollow space and an inflow opening for introducing a gas that is suitable for calibration,
inserting the calibration aid into the additive manufacturing device so that the energy beam is surrounded by the hollow space from the beam inlet to a measuring unit,
allowing the gas to flow into the hollow space of the calibration aid and
carrying out the calibration of the energy beam, wherein the measuring unit detects a beam property of the energy beam.

14. The method according to claim 13, wherein a beam power, an intensity distribution, a focus position, a focus geometry and/or a response behaviour of the energy beam is recorded as a beam property of the energy beam for calibration.

15. A method of using a calibration aid for calibrating an energy beam of an additive manufacturing device, wherein
the calibration aid with its hollow space is introduced into the additive manufacturing device so that the energy beam is surrounded by the hollow space from the beam inlet to a measuring unit,
a gas that is suitable for the calibration flows into the hollow space of the calibration aid, and
the calibration of the energy beam is performed, wherein the measuring unit detects a beam property of the energy beam.
